(19) United States
(12) Patent Application Publication
(10) Pub. No.: US 2008/0246899 A1
(43) Pub. Date: Oct. 9, 2008

(54) LCD and driving method thereof

(75) Inventors: Yi-Kuang Tsai, Hsin-chu (TW); Chia-Feng Hou, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: AU Optronics Corp., Hsinchu (TW)

(21) Appl. No.: 11/907,546

(22) Filed: Oct. 15, 2007

(30) Foreign Application Priority Data
Apr. 3, 2007 (TW) 096111809

(51) Int. Cl. G02F 1/1343

(52) U.S. Cl. 349/39

(57) ABSTRACT

The present invention relates to a driving system of a liquid crystal display and a driving method thereof. A storage capacitor voltage (V_{CS}) is applied to an auxiliary shielding storage capacitor electrode and a common electrode voltage (V_{com}) is applied to a common electrode in a liquid crystal display panel comprising of an upper substrate, a lower substrate, and a liquid crystal layer. Besides, a specific voltage is applied to a storage capacitor electrode and makes a predetermined voltage difference between the auxiliary shielding storage capacitor electrode and the common electrode, thereby improving the side light leakage of the liquid crystal display, enhancing the process when assembling the upper substrate and the lower substrate, and reducing the width of a black matrix shielding layer of the upper substrate to increase the aperture ratio.

### BACKGROUND OF THE INVENTION

1. Field of the Invention

The present invention relates to an LCD driving system and a driving method thereof, especially to a driving system and its driving method for using in a thin film transistor LCD.

2. Description of Related Art

The structure of a conventional thin film transistor LCD generally includes a liquid crystal display panel comprising an upper substrate, a lower substrate and a liquid crystal layer, wherein the liquid crystal layer is sealed between the upper substrate and the lower substrate. Further, the lower substrate has a plurality of pixel electrodes, and the upper substrate has a plurality of black matrix (BM) shielding patterns and a common electrode made of an Indium Tin Oxide (ITO) transparent thin film.

However, with regard to the region around boundary edge of pixel electrodes, the arrangement of liquid crystal molecules within this region cannot be controlled by means of controlling the voltage between the pixel electrodes and the common electrode. Therefore, light would leak out of this region thereby causing orthographic light leakage and side light leakage.

Further, FIG. 5A illustrates a top view of a conventional thin film transistor LCD, and FIG. 5B illustrates a cross-sectional view corresponding to the arrowhead mark of FIG. 5A, so as to learn more about the structure of a conventional Cs-on-Common H-type auxiliary shielding storage capacitor frame designed in response to the above light leakage problem.

As shown in FIGS. 5A and 5B, the lower substrate 1 includes a storage capacitor line 12, a metal layer 121 formed as an H pattern with the storage capacitor line 12, a gate insulator (GI) layer 16, a source line 11, a passivation layer 17, a pixel electrode 14 made of ITO, and an alignment film 18 formed thereon. Further, the upper substrate 2 includes a black matrix shielding pattern 100 of a color filter, a common electrode 13, and a common alignment film 20. The gate insulator 16 and the passivation layer 17 could be composed of Silicon Oxide, Silicon Nitride, and its similar compound.

The conventional LCD display principle is to control the voltages of the pixel electrode 14 and the common electrode 13, such that liquid crystal molecules 15 between the pixel electrode 14 and the common electrode 13 would be influenced by the voltage difference between the pixel electrode 14 and the common electrode 13, thereby changing the arrangement of the liquid crystal molecules 15, so as to control the light direction within the liquid crystal molecules 15 and form a variety of gray scales in combination with a polarizing sheet.

Therefore, the way that the Cs-on-Common H-patterned auxiliary shielding storage capacitor frame improves the above light leakage problem is to utilize the auxiliary storage capacitor line 12 to form an H-patterned metal layer 121 around the boundary edge of the pixel electrode 14, so as to shield the light leakage from the edge of the pixel electrode 14. Further, regarding the design of the color filter, a black matrix shielding pattern 100 is disposed above a gap between two neighbor pixel electrodes 14, for blocking the orthographic light leakage and side light leakage between the source line 11 and the H-patterned metal layer 121 of the auxiliary storage capacitor.

On the other hand, as to electricity, please refer to FIG. 6 showing the electronic signal of the conventional LCD panel. Conventionally, the voltage difference between an auxiliary shielding storage capacitor voltage (V_{CS}) of the H-patterned metal layer 121 of the auxiliary storage capacitor at two sides of the source line 11 and a common electrode voltage (V_{com}) of the common electrode 13 is down to zero, which means, the voltages of the H patterned metal layer 121 and the common electrode 13 are identical, V_{CS}=V_{com}. Therefore, with regard to the liquid crystal molecules 15 between the H patterned metal layer 121 and the common electrode 13, the light transmittance of the molecule arrangement direction is high.

However, if the lower substrate 1 and the upper substrate 2 are not properly sealed during the sealing process, or if the overlap between the black matrix shielding layer 100 and the H-patterned metal layer 121 changes, the liquid crystal molecules 15 under such arrangement status still tend to generate side light leakage (shown as the directions indicated by arrows in FIG. 5B).

Therefore, according to the above description, in the conventional Cs-on-Common H-type auxiliary shielding storage capacitor frame, the light would still leak from the directions indicated by arrows shown in FIG. 5B. That is, the physical shielding effect of the conventional Cs-on-Common H-type auxiliary shielding storage capacitor frame cannot completely shield the side light leakage of the edge region of the pixel electrode 14.

Further, in conventional designs, there are two ways applied to prevent the side light leakage problem: 1. reducing the width between the source line 11 and the H-patterned metal layer 121 of the auxiliary storage capacitor at two sides of the source line 11, 2. increasing the width of the black matrix shielding layer 100.

However, the former is subject to the influence of the process stability thereby causing the source line 11 to be coupled to the auxiliary storage capacitor line 12 and resulting in a bad driving problem; while the latter increases the width of the black matrix shielding layer thereby reducing the aperture ratio.

Therefore, it is desirable to provide a better LCD driving system and driving method thereof in a more convenient and accurate way so as to mitigate and/or obviate the aforementioned problems.

### SUMMARY OF THE INVENTION

An object of the present invention is to provide an LCD driving method for improving the side light leakage.

Another object of the present invention is to provide an LCD driving method adapted to a design of reducing the width of the black matrix shielding layer and increasing the aperture ratio.

Another object of the present invention is to provide an LCD driving method for reducing the limitation of the assembly process of the upper substrate and the lower substrate to increase the yield.

Another object of the present invention is to provide an LCD driving method for reducing the cost of the printed wire board.

Another object of the present invention is to provide a voltage difference between the H-patterned auxiliary shielding storage capacitor and the common electrode.

To achieve the above objects, the present invention provides an LCD driving method. The LCD comprises an LCD panel comprising an upper substrate, a lower substrate and a liquid crystal layer, wherein the liquid crystal layer is sealed between the upper substrate and the lower substrate. The lower substrate further includes a plurality of pixel electrodes and an auxiliary shielding storage capacitor electrode, and the upper substrate includes a black matrix shielding layer and a common electrode. The common electrode is disposed on a surface of the upper substrate or the black matrix shielding layer, and the auxiliary shielding storage capacitor electrode is disposed under the pixel electrodes and arranged along edges of the pixel electrodes. The black matrix shielding layer is arranged corresponding to a gap between each two adjacent pixel electrodes. The driving method comprises the following steps of: applying a storage capacitor voltage to the auxiliary shielding storage capacitor electrode; and applying a common electrode voltage to the common electrode, and controlling the difference between the storage capacitor voltage and the common electrode voltage to form a predetermined voltage difference.

To achieve the above objects, the present invention provides an LCD driving system, which comprises: an LCD panel, comprising an upper substrate, a lower substrate and a liquid crystal layer, wherein the liquid crystal layer is sealed between the upper substrate and the lower substrate, the lower substrate further comprising a plurality of pixel electrodes and an auxiliary shielding storage capacitor electrode, the upper substrate comprising a black matrix shielding layer and a common electrode, the common electrode disposed on a surface of the upper substrate or the black matrix shielding layer, the auxiliary shielding storage capacitor electrode disposed under the pixel electrodes and arranged along edges of the pixel electrodes, the black matrix shielding layer arranged corresponding to a gap between each two adjacent pixel electrodes; a voltage converter for receiving an operating voltage input and providing a storage capacitor voltage and a common electrode voltage, wherein a predetermined voltage difference exists between the storage capacitor voltage and the common electrode voltage; at least one source driver, electronically connected to the voltage converters and the LCD panel, for providing a plurality of data signals to the LCD panel; and at least one gate driver, electronically connected to the voltage converters and the LCD panel, for providing a plurality of scan signals to the LCD panel; wherein the storage capacitor voltage is applied to the auxiliary shielding storage capacitor electrode, and the common electrode voltage is applied to the common electrode, so as to keep the predetermined voltage difference between the auxiliary shielding storage capacitor electrode and the common electrode.

Accordingly, liquid crystal material placed between the auxiliary shielding storage capacitor electrode and the common electrode with the predetermined voltage difference would be driven to influence the light transmittance between the auxiliary shielding storage capacitor electrode and the common electrode.

### BRIEF DESCRIPTION OF THE DRAWINGS

FIG. 1A illustrates a block diagram of an LCD driving system of one preferred embodiment according to the present invention.

FIG. 1B illustrates a schematic drawing of a voltage converter of the LCD driving system of one preferred embodiment according to the present invention.

FIGS. 2A˜2D illustrate top views of a pixel of one preferred embodiment according to the present invention.

FIG. 2E illustrates a cross-sectional view of an LCD pixel of one preferred embodiment according to the present invention.

FIG. 3 illustrates an electronic signal schematic drawing of a storage capacitor voltage (V_{CS}) and a common electrode voltage (V_{com}) within a pixel of one preferred embodiment according to the present invention.

FIG. 4 illustrates an electronic signal schematic drawing of a storage capacitor voltage (V_{CS}) and a common electrode voltage (V_{com}) within a pixel of another preferred embodiment according to the present invention.

FIG. 5A illustrates a top view of a conventional thin film transistor LCD pixel.

FIG. 5B illustrates a cross-sectional view of a conventional thin film transistor LCD pixel.

FIG. 6 illustrates an electronic signal schematic drawing of a conventional pixel.

### DETAILED DESCRIPTION OF THE PREFERRED EMBODIMENT

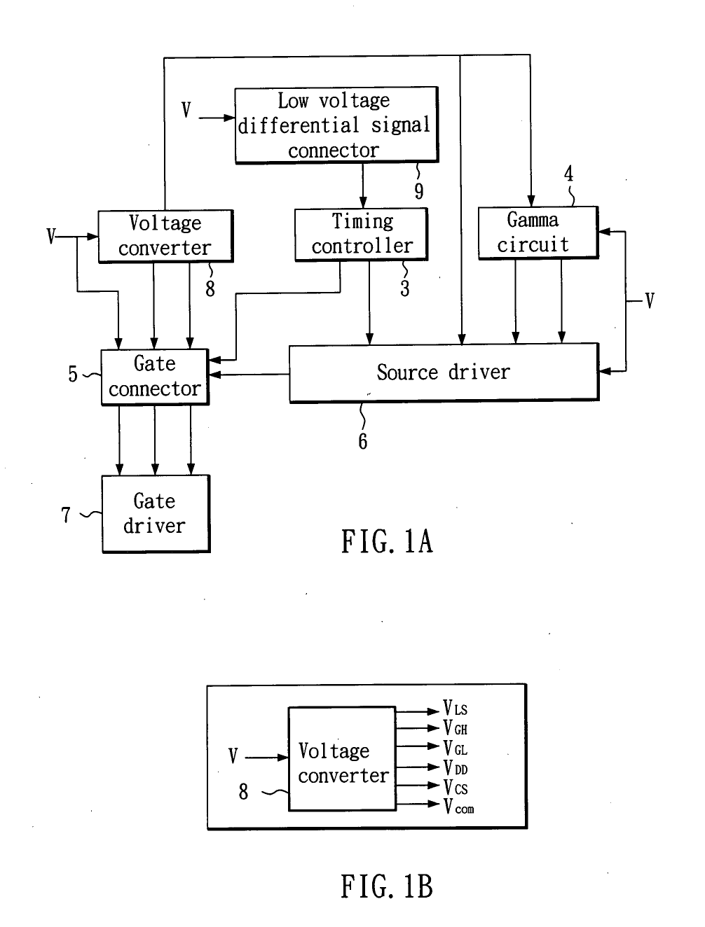

Please refer to FIGS. 1A and 1B. FIG. 1A illustrates a block diagram of an LCD driving system of one preferred embodiment according to the present invention, and FIG. 1B illustrates a schematic drawing of a voltage converter of the LCD driving system of one preferred embodiment according to the present invention.

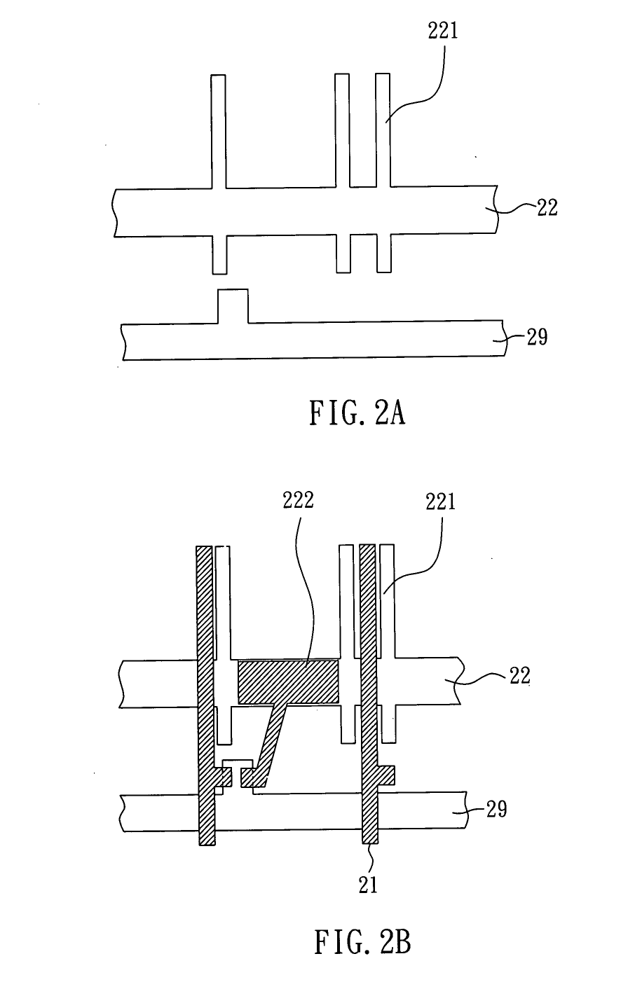

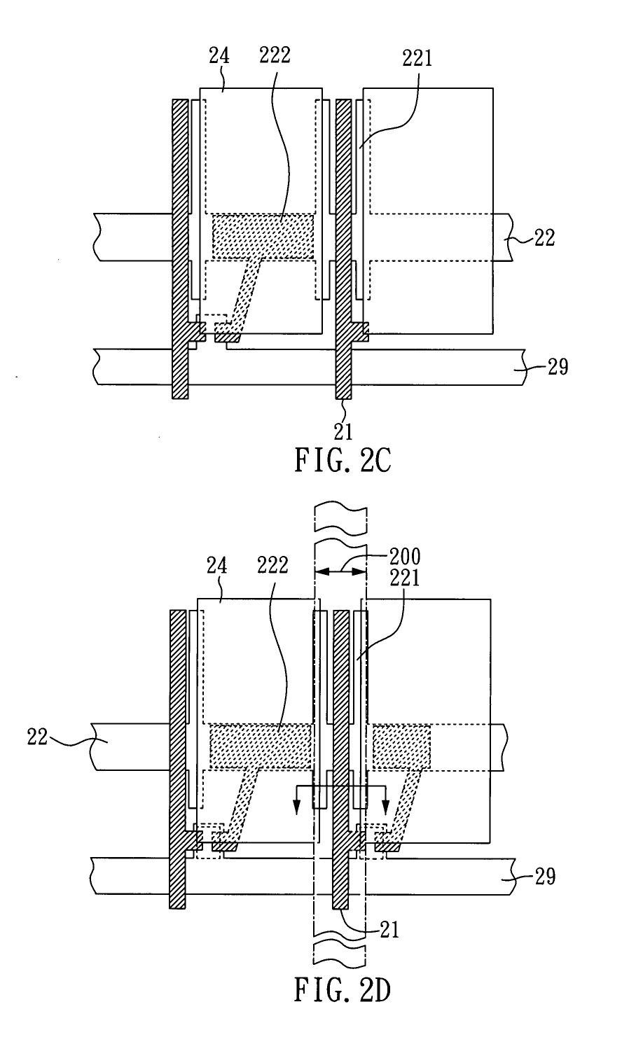

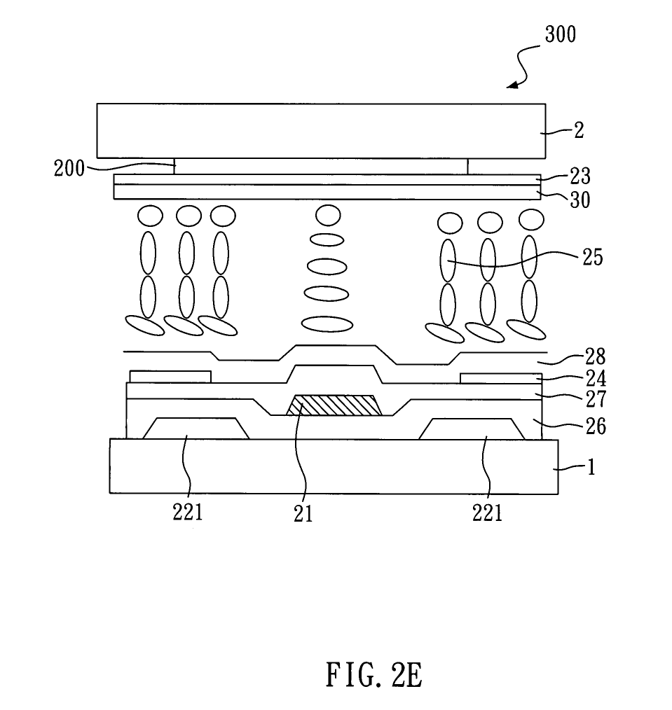

The LCD driving system as shown in FIGS. 1A and 1B is electronically connected to a plurality of pixel electrodes 24 (shown in FIGS. 2A and 2B), and comprises a low voltage differential signal connector 9, a voltage converter 8, a timing controller 3, a gamma circuit 4, a gate connector 5, a source driver 6 and a gate driver 7.

The low voltage differential signal connector 9 is electronically connected to the timing controller 3, the voltage converter 8 is electronically connected to the gamma circuit 4, the gate connector 5 and the source driver 6, the timing controller 3 is electronically connected to the gate connector 5 and the source driver 6, the gamma circuit 4 is electronically connected to the source driver 6, the source driver 6 is electronically connected to the gate connector 5, and the gate connector 5 is electronically connected to the gate driver 7. Further, the source driver 6 and the gate driver 7 are electronically connected to an LCD panel 300 (shown in FIG. 2E) via source lines 21 (shown in FIG. 2B) and gate lines 29 (shown in FIG. 2B), respectively.

Moreover, the gamma circuit 4 provides a gamma reference voltage to the source driver 6, the timing controller 3 outputs electronic signals to the source driver 6 and the gate driver 7 to control the operation of the source driver 6 and the gate driver 7, such that the source driver 6 could output display data to the source lines 21, and the gate driver 7 could output scan signals to the gate lines 29, so as to transmit the display data and the scan signals to the LCD panel 300 via the source lines 21 and the gate lines 29.

As to the system operation, first, an operating voltage V is inputted to the low voltage differential signal connector 9, the voltage converter 8, the gamma circuit 4 and the source driver 6. The low voltage differential signal connector 9 provides the operating voltage V to the timing controller 3, and the voltage converter 8 performs a voltage increasing or a voltage decreasing process to the operating voltage V for providing various kinds of voltages, such as a highest gate voltage (V_{GH}), a lowest gate voltage (V_{GL}), a storage capacitor voltage (V_{CS}) and a common electrode voltage (V_{com}), to supply the voltage required by the LCD panel during operation. Then, the printed wire board (PWB) (not shown in figures) or the circuit (not shown in figures) on the side of the lower substrate 1 transmits the voltage outputted by the voltage converter 8 to the gate driver 7. The electronic signals of V_{GH} and V_{GL} are converted by the gate driver 7 connected to the gate connector 5, so as to drive the gate lines 29 of the LCD panel.

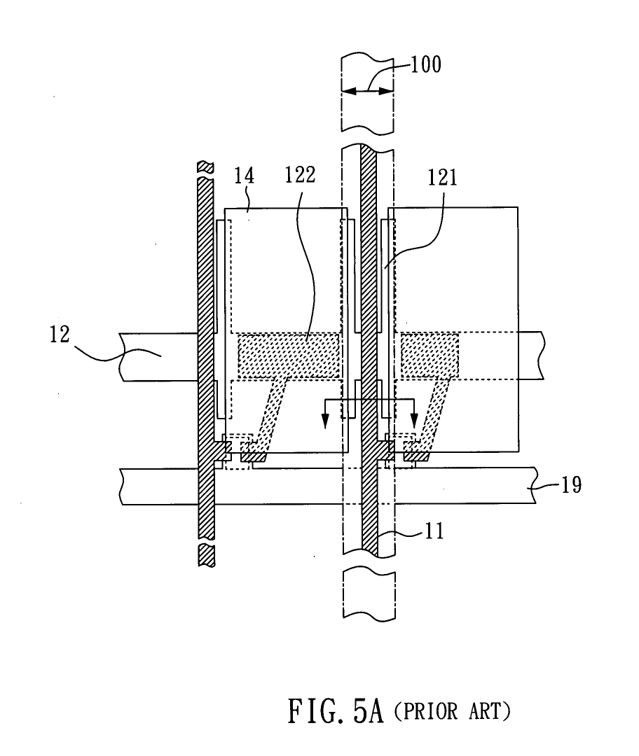

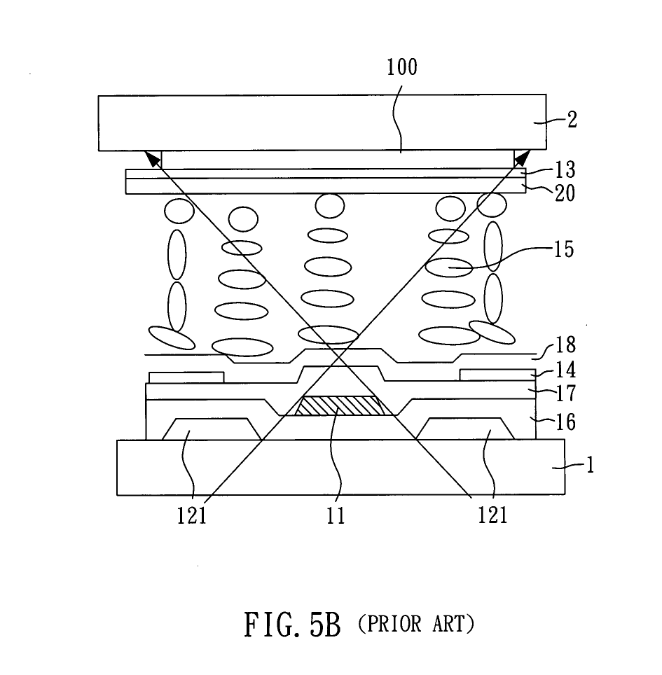

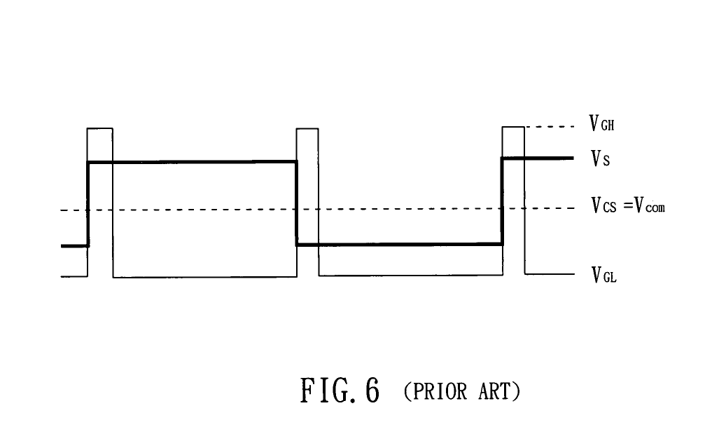

Please refer to FIGS. 2A˜2E. FIGS. 2A˜2D illustrate top views of a pixel of one preferred embodiment according to the present invention by showing the layer relation of each layer according to the order during the manufacturing process. FIG. 2E illustrates a cross-sectional view corresponding to the arrow mark region of FIG. 2D. Please note that FIGS. 2A˜2E illustrate a similar structure in appearance as shown in FIGS. 5A and 5B for an easier description.

Similarly, the lower substrate 1 includes a gate line 29 and a storage capacitor line 22 made of the same layer of metal as the lowest layer structure shown in FIG. 2A. An auxiliary shielding storage capacitor electrode 221 connected to the storage capacitor line 22 is formed as well. Next, a gate insulator 26 is formed, then, as shown in FIG. 2B, a source line 21 and a storage capacitor area 222 made of the same layer of the source line 21 are formed. Then, a passivation layer 27, a pixel electrode 24 as shown in FIG. 2C, are formed. Finally, an alignment film 28 is formed. Referring to FIG. 2E, the upper substrate 2 includes a black matrix shielding layer 200 of a color filter (not shown), in which the black matrix shielding layer 200 is arranged on a position corresponding to a gap between the adjacent pixel electrodes 24 as shown in FIG. 2D. Next, a layer of a common electrode 23 is formed as shown in FIG. 2E, in which the common electrode 23 is disposed on a surface of the black matrix shielding layer 200. Alternatively, the common electrode 23 is disposed on a surface of the substrate 2. Finally, a layer of a common alignment film 30 is formed. The passivation layer 27 could be formed as the structure of single-layer or multi-layer by inorganic material of silicon oxide, silicon nitride and its similar compound, or organic material.

On the lower substrate 1, the auxiliary shielding storage capacitor electrode 221 is arranged along the boundary edge of the pixel electrodes 24. Further, in the embodiment, the auxiliary shielding storage capacitor electrode 221 and the storage capacitor line 22 are formed as an H-patterned metal layer, in which the auxiliary shielding storage capacitor electrode 221 is formed corresponding to the edges of the abovementioned pixel electrode 24.

In this embodiment, a storage capacitor voltage (V_{CS}) provided by the voltage converter 8 is applied to the auxiliary shielding storage capacitor electrode 221, i.e. the H-patterned metal layer of the storage capacitor line 22, a common electrode voltage (V_{com}) provided by the voltage converter 8 is applied to the common electrode 23, and the difference between the storage capacitor voltage (V_{CS}) and the common electrode voltage (V_{com}) is controlled to form a predetermined voltage difference. In this embodiment, the storage capacitor voltage (V_{CS}) is less than about −2V, the common electrode voltage (V_{com}) is about 3˜5V. Therefore, the predetermined voltage difference formed between the auxiliary shielding storage capacitor electrode 221 and the common electrode 23 is greater than about 5˜7V, thereby influencing the arrangement direction of liquid crystal molecules 25 between the auxiliary shielding storage capacitor electrode 221 and the common electrode 23, further influencing the light transmittance between auxiliary shielding storage capacitor electrode 221 and the common electrode 23, so as to eliminate light leaked out of the edge of the black matrix shielding layer 200 to avoid the side light leakage problem. Accordingly, the width of the black matrix shielding layer could be narrowed to increase the aperture ratio as well as improve the assembly process of the LCD panel.

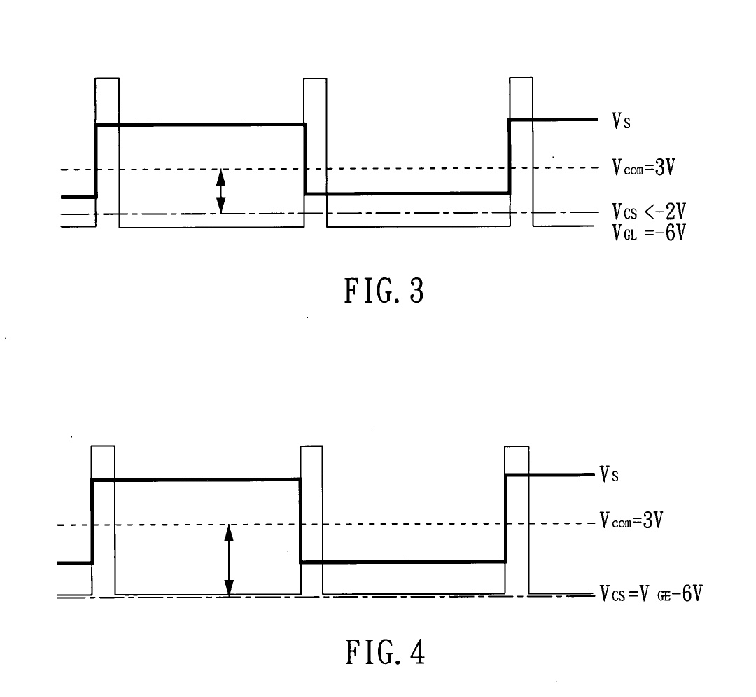

Please refer to FIG. 3 illustrating an electronic signal schematic drawing of the storage capacitor voltage (V_{CS}) and the common electrode voltage (V_{com}) within a pixel of one preferred embodiment according to the present invention. Shown as the arrow, the predetermined voltage between the storage capacitor voltage (V_{CS}) and a common electrode voltage (V_{com}) is 5V.

In another preferred embodiment of the present invention, a voltage output source equivalent to a lowest gate voltage (V_{GL}) is directly pulled out from the voltage converter 8 for being connected to the auxiliary shielding storage capacitor electrode 221, for applying the storage capacitor voltage (V_{CS}) with the voltage identical to the lowest gate voltage (V_{GL}) to the auxiliary shielding storage capacitor electrode 221. That is, V_{GL}=V_{CS}. In this embodiment, the lowest gate voltage (V_{GL}) is −6V, the common electrode voltage (V_{com}) is 3˜5V. Therefore, comparing to the previous embodiment, there is a larger predetermined voltage difference formed between the auxiliary shielding storage capacitor electrode 221 and the common electrode 23, i.e. 9˜11V, thereby much more influencing the light transmittance of the liquid crystal molecules 25 between the auxiliary shielding storage capacitor electrode 221 and the common electrode 23, so as to more efficiently avoid the side light leakage problem. Therefore, the manufacturing cost of the printed wire board is reduced by saving the circuit design for providing the storage capacitor voltage (V_{CS}) of the voltage converter 8.

Please refer to FIG. 4 illustrating an electronic signal schematic drawing of the storage capacitor voltage (V_{CS}) and the common electrode voltage (V_{com}) within a pixel of another preferred embodiment according to the present invention. Shown as the arrow, the predetermined voltage difference between the storage capacitor voltage (V_{CS}) and a common electrode voltage (V_{com}) is 9V.

According to the above description, an auxiliary shielding storage capacitor electrode is formed on a position of the lower substrate corresponding to the edge of pixel electrode, a storage capacitor voltage is applied to the auxiliary shielding storage capacitor electrode, a common electrode voltage is applied to the common electrode, and the difference between the storage capacitor voltage and the common electrode voltage is a predetermined voltage difference, such that the liquid crystal material between the auxiliary shielding storage capacitor electrode and the common electrode would be influenced by the predetermined voltage difference to change its optics nature, so as to improve the side light leakage problem of the LCD.

Although the present invention has been explained in relation to its preferred embodiment, it is to be understood that many other possible modifications and variations can be made without departing from the spirit and scope of the invention as hereinafter claimed.

What is claimed is:

1. An LCD driving method, the LCD comprising an LCD panel comprising an upper substrate, a lower substrate and a liquid crystal layer, wherein the liquid crystal layer is sealed between the upper substrate and the lower substrate, the lower substrate further comprising a plurality of pixel electrodes and an auxiliary shielding storage capacitor electrode, the upper substrate comprising a black matrix shielding layer and a common electrode, the common electrode being disposed on a surface of the upper substrate or the black matrix shielding layer, the auxiliary shielding storage capacitor electrode being disposed under the pixel electrodes and arranged along edges of the pixel electrodes, the black matrix shielding layer being arranged corresponding to a gap between two adjacent pixel electrodes, the driving method comprising the following steps:
applying a storage capacitor voltage to the auxiliary shielding storage capacitor electrode; and
applying a common electrode voltage to the common electrode; and
controlling a difference between the storage capacitor voltage and the common electrode voltage to form a predetermined voltage difference.

2. The LCD driving method as claimed in claim 1, wherein the storage capacitor voltage and the common electrode voltage are respectively provided from a voltage converter by adjusting an operating voltage.

3. The LCD driving method as claimed in claim 1, wherein the storage capacitor voltage is provided by a voltage converter for providing a lowest gate driving voltage.

4. The LCD driving method as claimed in claim 1, wherein liquid crystal layer disposed between the auxiliary shielding storage capacitor electrode and the common electrode with the predetermined voltage difference is driven.

5. The LCD driving method as claimed in claim 1, wherein the auxiliary shielding storage capacitor electrode and a storage capacitor line are formed as an H-patterned metal layer.

6. The LCD driving method as claimed in claim 1, wherein the predetermined voltage difference is greater than about 5 volts.

7. The LCD driving method as claimed in claim 1, wherein the storage capacitor voltage is less than the common electrode voltage, and the storage capacitor voltage is less than about −2 volts.

8. The LCD driving method as claimed in claim 1, wherein the storage capacitor voltage is the same as a lowest gate voltage.

9. The LCD driving method as claimed in claim 1, wherein the common electrode voltage is about 3 to 5 volts.

10. An LCD driving system, comprising:
an LCD panel, comprising an upper substrate, a lower substrate and a liquid crystal layer sealed between the upper substrate and the lower substrate, the lower substrate further comprising a plurality of pixel electrodes and an auxiliary shielding storage capacitor electrode, the upper substrate comprising a black matrix shielding layer and a common electrode, the common electrode being disposed on a surface of the upper substrate or the black matrix shielding layer, the auxiliary shielding storage capacitor electrode being disposed under the pixel electrodes and arranged along edges of the pixel electrodes, the black matrix shielding layer being arranged corresponding to a gap between two adjacent pixel electrodes;
a voltage converter for receiving an operating voltage input and providing a storage capacitor voltage and a common electrode voltage, wherein a predetermined voltage difference exists between the storage capacitor voltage and the common electrode voltage;
at least one source driver electronically connected to the voltage converter and the LCD panel, for providing a plurality of data signals to the LCD panel; and
at least one gate driver electronically connected to the voltage converter and the LCD panel, for providing a plurality of scan signals to the LCD panel;
wherein the storage capacitor voltage is applied to the auxiliary shielding storage capacitor electrode, and the common electrode voltage is applied to the common electrode, so as to keep the predetermined voltage difference between the auxiliary shielding storage capacitor electrode and the common electrode.

11. The LCD driving system as claimed in claim 10, further comprising:
a low voltage differential signal connector, for receiving the operating voltage input;
a gamma circuit, electronically connected to the voltage converter, for providing a gamma reference voltage to the source driver; and
a timing controller, electronically connected to the low voltage differential signal connector, the gate driver and the source driver;
wherein the low voltage differential signal connector provides the operating voltage to the timing controller, such that the timing controller outputs at least one electronic signal to the source driver and the gate driver to control the operation of the source drive rand the gate driver.

12. The LCD driving system as claimed in claim 10, wherein the voltage converter further provides a gate driving lowest voltage to the storage capacitor voltage.

13. The LCD driving system as claimed in claim 10, wherein the liquid crystal layer disposed between the auxiliary shielding storage capacitor electrode and the common electrode with the predetermined voltage difference is driven.

14. The LCD driving system as claimed in claim 10, wherein the auxiliary shielding storage capacitor electrode and a storage capacitor line are formed as an H-patterned metal layer.

15. The LCD driving system as claimed in claim 10, wherein the predetermined voltage difference is greater than about 5 volts.

16. The LCD driving system as claimed in claim 10, wherein the storage capacitor voltage is less than the common electrode voltage, and the storage capacitor voltage is less than about −2 volts.

17. The LCD driving system as claimed in claim 10, wherein the storage capacitor voltage is the same as a lowest gate voltage, and the common electrode voltage is about 3 to 5 volts.
